(19) United States
(12) Patent Application Publication
(10) Pub. No.: US 2014/0082533 A1
(43) Pub. Date: Mar. 20, 2014

(54) Navigation Interface for Electronic Content

(71) Applicant: ADOBE SYSTEMS INCORPORATED, San Jose, CA (US)

(72) Inventor: Yohko Aurora Fukuda Kelley, Woodinville, WA (US)

(73) Assignee: Adobe Systems Incorporated, San Jose, CA (US)

(21) Appl. No.: 13/623,204

(22) Filed: Sep. 20, 2012

(51) Int. Cl. G06F 3/048

(52) U.S. Cl. 715/764

(57) ABSTRACT

Systems and methods are provided for providing a navigation interface to access or otherwise use electronic content items. One embodiment involves a processor executing a content management application to provide a navigation interface. The navigation interface includes multiple visual indicators. Each visual indicator corresponds to an item of electronic content. The embodiment also involves the content management application expanding the first tab in response to receiving a first input selecting a visual indicator in the navigation interface. The embodiment also involves the content management application presenting information describing a respective item of electronic content corresponding to the selected visual indicator in response to receiving a second input to the selected visual indicator. The embodiment also involves the content management application rendering the respective item of electronic content for display in response to receiving a third input to the selected tab.

### TECHNICAL FIELD

This disclosure relates generally to computer-implemented methods and systems and more particularly relates to navigation interfaces for using electronic content.

### BACKGROUND

Electronic devices, such as tablet computers and mobile phones, may include a touch screen that can detect the presence and location of a touch within a display area for rendering electronic content, such as text, email, music, photographs, images, audio, videos, blogs, and other content. Touch screens may have smaller display areas than monitors used for computing devices such as desktop computers and laptop computers. Touch screen devices also rely on touch inputs from objects such as a stylus or a finger to navigate electronic content, rather than an external mouse or touchpad. Due to the reduced amount of display area for touch screen devices as opposed to computing devices using external monitors, the use of touch inputs from a stylus or a finger on touch screen devices such as tablet computers and smart phones can reduce the precision and/or ease of navigating electronic content on devices. Improved systems and methods for efficient use of space in a display area of a touch-screen device are therefore desirable.

### SUMMARY

One embodiment involves a processor executing a content management application to provide a navigation interface. The navigation interface includes multiple visual indicators. Each visual indicator corresponds to an item of electronic content. The embodiment also involves the content management application expanding a first tab in response to receiving a first input selecting a visual indicator in the navigation interface. The embodiment also involves the content management application presenting information describing a respective item of electronic content corresponding to the selected visual indicator in response to receiving a second input to the selected visual indicator. The embodiment also involves the content management application rendering the respective item of electronic content for display in response to receiving a third input to the selected tab.

These illustrative embodiments are mentioned not to limit or define the disclosure, but to provide examples to aid understanding thereof. Additional embodiments are discussed in the Detailed Description, and further description is provided there.

### BRIEF DESCRIPTION OF THE FIGURES

These and other features, embodiments, and advantages of the present disclosure are better understood when the following Detailed Description is read with reference to the accompanying drawings, where:

FIG. 1 is a block diagram depicting example computing systems for implementing certain embodiments;

FIG. 2 is a modeling diagram illustrating an example navigation interface for browsing electronic content items;

FIG. 3 is a modeling diagram illustrating selecting a tab corresponding to an electronic content item in the navigation interface;

FIG. 4 is a modeling diagram illustrating an example scrollable navigation interface for browsing electronic content items;

FIG. 5 is a modeling diagram illustrating scrolling of the example scrollable navigation interface for browsing electronic content items;

FIG. 6 is a modeling diagram illustrating selecting a tab corresponding to an electronic content item in the scrollable navigation interface;

FIG. 7 is a modeling diagram illustrating the navigation interface displaying metadata describing a selected electronic content item in the scrollable navigation interface;

FIG. 8 is a modeling diagram illustrating the navigation interface displaying a selected electronic content item in an integrated viewer;

FIG. 9 is a modeling diagram illustrating the navigation interface executing an external viewer application for displaying a selected electronic content item;

FIG. 10 is a flow chart illustrating an example method for providing a navigation interface; and

FIG. 11 is a flow chart illustrating an alternative example method 500 for providing a navigation interface.

### DETAILED DESCRIPTION

Computer-implemented systems and methods are disclosed for providing a navigation interface for accessing or otherwise using electronic content. For example, a navigation interface may include a bar positioned at an edge of a display area of a touch screen device. The navigation interface may include multiple visual indicators, such as tabs, corresponding to respective electronic content items, such as videos. The tabs may thus provide a ribbon interface along the edge of the touch screen. The navigation interface is responsive to gestures such as (but not limited to) pinching, tweaking, sliding of a finger or stylus, and the like. The navigation interface progressively displays additional content or information about the additional content based on a combination of inputs received to the navigation interface. For example, a swiping motion received by a tab may expand the size of the tab in order to receive additional inputs by an input device, such as a stylus interacting with the touch screen. A single tap received by an expanded tab may cause the touch screen to display information about a video associated with the tab, such as the title, duration, and/or description of the video content. A double tap may cause a video player to be executed for rendering the video for display on the touch screen device.

The content management application can thus provide a persistent navigation interface that allows for navigation among electronic content items, provides information about the electronic content items, and/or renders a selected electronic content item for display. The content management application can progressively navigate to an electronic content item, provide information about the content item, and render the content item based on a combination of inputs received via the navigation interface. Providing a progressive disclosure of information regarding an electronic content item can provide an efficient use of limited area on a display device rendering the electronic content for display.

In accordance with one embodiment, a content management application provides a navigation interface. For example, a navigation interface can be a series of tabs positioned at a first edge of a touch screen. Each visual indicator corresponds to an item of electronic content. The content management application expands the first tab in response to receiving a first input selecting a visual indicator in the navigation interface. For example, a content management application may receive a tapping input to the tab. In response to receiving the tapping input on a tab representing an electronic content item, the content management application can enlarge the tab. In some embodiments, a tab may increase in size in response to the second input but remain partially hidden. The indicator may increase to a full size in response to an additional input. A full size can span the touch screen. The content management application presents information describing a respective item of electronic content corresponding to the selected visual indicator in response to receiving a second input to the selected visual indicator. The content management application renders the respective item of electronic content for display in response to receiving a third input to the selected tab. For example, the content management application may receive a dragging input or a clicking input to the enlarged tab. In response to a dragging input or a clicking input to the enlarged tab, the content management application can render some or all of the electronic content item for display.

As used herein, the term “electronic content” is used to refer to any type of media that can be rendered for display or use at a computing system or other electronic device. Electronic content can include text or multimedia files, such as images, video, audio, or any combination thereof. Electronic content can also include application software that is designed to perform one or more specific tasks at a computing system.

As used herein, the term “tab” is used to refer to a visual indicator rendered for display at a display device and corresponding to a respective electronic content item and/or a collection of electronic content items.

In additional or alternative embodiments, the content management application can display metadata describing electronic content associated with the tab in response to receiving an additional input to a selected tab via the navigation interface. The metadata can include, for example, the title of the content or a textual summary of the content.

As used herein, the term “metadata” is used to refer to information associated with (and generally but not necessarily stored with) an electronic content item that describes a feature of the electronic content item. Metadata may describe a location or identification of electronic content. Non-limiting examples of metadata for an electronic content item can include a title, author, keywords, and the like. Metadata may also describe a relationship between a first electronic content item and a second electronic content item, such as how the first and second electronic content items can be combined and sequenced for a multimedia presentation. Metadata can also describe when and how an electronic content item was created, a file type and other technical information for the electronic content item, and/or access rights for the electronic content item. In some embodiments, metadata includes data included in the electronic content item that is not displayed by a client application using the electronic content item.

In additional or alternative embodiments, a tab may be selected in response to the navigation interface receiving a strumming input. In some embodiments, the content management application can expand a tab in response to the tab being contacted during the strumming input. In other embodiments, the content management application can provide information about an electronic content item, such as a duration of a video, in response to a tab corresponding to the electronic content item being contacted during the strumming input.

As used herein, the term “strumming” is used to refer to one or more inputs to a display device providing a continuous contact with the display device, such as a finger or stylus moving across the touch screen. A strumming input can be received by an object in a graphical interface in a direction in which the object is stationary. For example, a navigation interface may include a bar positioned at an edge of a touch screen. The navigation interface may be configured such that the navigation interface is stationary in a direction perpendicular to the edge of the touch screen, such as a vertical direction for a navigation interface positioned at a top or bottom edge or a horizontal direction for a navigation interface positioned at a left or right edge. An input source, such as a stylus or finger, may provide a strumming input by contacting the touch screen and moving along a path that includes the navigation interface and in a direction for which the navigation interface is stationary.

In additional or alternative embodiments, the content management application receives additional inputs to perform additional actions on the electronic content item being rendered for display on the display. Non-limiting examples of inputs to the navigation interface can include pinching, flicking, strumming, tapping, dragging, a combination of touch gestures, and the like. For example, a pinching input can be used to expand the size of the electronic content item, zoom in on a portion of the electronic content item, or collapse the electronic content item.

As used herein, the term “pinch” is used to refer to a group of inputs that includes at least two inputs contacting respective points on a touch screen where an object is rendered for display and at least two additional inputs moving toward one another or away from one another. Two inputs moving toward one another can cause the object to shrink in size. Two inputs moving away from one another can cause the object to expand in size.

As used herein, the term “tap” is used to refer to one or more inputs to a touch screen contacting a point on a touch screen where an object is rendered for display and ceasing contact without movement in any direction on the touch screen.

As used herein, the term “drag” is used to refer to a group of inputs that include a first input maintaining contact at a point on a touch screen where an object is rendered for display and a second input moving in a direction away from the object. A computing device in communication with a touch screen can determine an end point for the object based on a stopping position of the second input on the touch screen.

As used herein, the term “flick” is used to refer to a group of inputs that include a first input contacting a point on a touch screen where an object is rendered for display and a second input moving in a direction away from the object. In some embodiments, the first input may not maintain contact with the object. A computing device in communication with a touch screen can determine an end point for the object based at least in part on the velocity of the second input.

In some embodiments, the navigation interface can be rendered for display on the display device as a bar or a ribbon at an edge of a display screen of a display device. The navigation interface can remain stationary at the edge of the display screen.

In additional or alternative embodiments, the content management application can adaptively render the navigation interface on different display devices based on display characteristics of the display device. Non-limiting examples of display characteristics include display screen size, a display screen shape, or a display screen resolution. The content management application can modify the size of the navigation interface based on display characteristics of the display device. In other embodiments, the content management application can modify the size of tabs within the navigation interface based on display characteristics of the display device. In other embodiments, the content management application can modify the number of tabs within the navigation interface based on display characteristics of the display device. For example, the content management application can reduce the number of tabs displayed in the navigation interface and provide a scrolling feature for scrolling through the tabs rendered for display.

The tabs or other visual indicators of the navigation interface can be populated via any suitable process. In some embodiments, the content management application can populate the navigation interface with tabs based on automatically detecting the electronic content items in one or more locations in the memory of the computing device executing the content management application. In other embodiments, the content management application can populate the navigation interface with tabs based on a playlist provided to or otherwise accessible by the content management application. The playlist can identify the electronic content items to be included in the navigation interface. A playlist can be stored in memory on a computing device executing the content management application or provided by a content provider in communication with the content management application, such as (but not limited to) a website. For example, a subscription service accessible via the content management application can select electronic content items of interest. The subscription service can provide a playlist identifying the locations from which the electronic content items of interest can be accessed.

In other embodiments, the content management application can perform a search of one or more locations in response to receiving a search request. The content management application can identify the item of electronic content that includes one or more attributes corresponding to at least one search criterion. Non-limiting examples of search criteria include a file type (such as, but not limited to, video files or image files), a text string matching at least part of a metadata value describing a title of an electronic content item, a text string matching at least part of a metadata value describing an electronic content item, and the like. In some embodiments, the content management application can perform a search in the memory of the computing device executing the content management application. In other embodiments, the content management application can perform a search of a remote location, such as the Internet or other content locations accessible via a data network.

In some embodiments, the navigation interface can display a given electronic content item. For example, selecting a tab corresponding to an electronic content item such as a video can cause the content management application to execute a video player within embedded within the navigation interface. In other embodiments, the content management application can cause a separate application to execute at the computing device to render the electronic content item for display. For example, selecting a tab corresponding to an electronic content item such as a video can cause the content management application to execute a video player separate from the content management application.

In additional or alternative embodiments, none of the electronic content items may be rendered for display prior to the navigation interface receiving a first input. The navigation interface may provide a persistent interface for navigating to and executing various electronic content items or for displaying information about the various electronic content items without rendering the electronic content items for display.

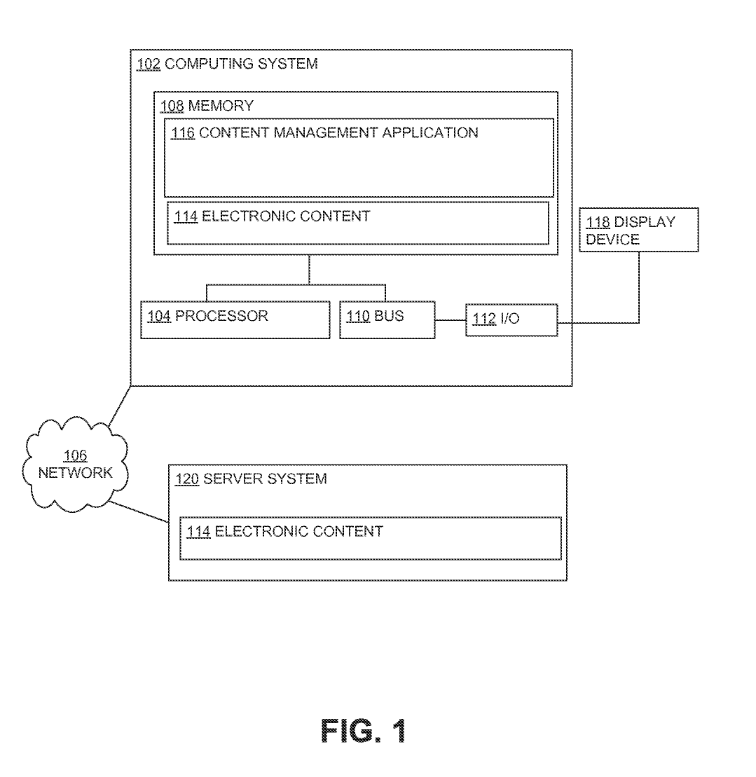

Referring now to the drawings, FIG. 1 is a block diagram depicting an example computing system 102 for implementing certain embodiments.

The computing system 102 comprises a computer-readable medium such as a processor 104 that is communicatively coupled to a memory 108 and that executes computer-executable program instructions and/or accesses information stored in the memory 108. The processor 104 may comprise a microprocessor, an application-specific integrated circuit (“ASIC”), a state machine, or other processor. The processor 104 can include any of a number of computer processing devices, including one. Such a processor can include or may be in communication with a computer-readable medium storing instructions that, when executed by the processor 104, cause the processor to perform the steps described herein.

The computing system 102 may also comprise a number of external or internal devices such as input or output devices. For example, the computing system 102 is shown with an input/output (“I/O”) interfaces 112 and display device 118. A bus 110 can also be included in the computing system 102. The bus 110 can communicatively couple one or more components of the computing system 102.

The computing system 102 can modify, access, or otherwise use electronic content 114. The electronic content 114 may be resident in any suitable computer-readable medium and execute on any suitable processor. In one embodiment, the electronic content 114 can reside in the memory 108 at the computing system 102. In another embodiment, the electronic content 114 can be accessed by the computing system 102 from a server system 120 via the network 106. The server system 120 can include any suitable computing system for hosting the electronic content 114. In one embodiment, the server system 120 may be a single computing system. In another embodiment, the server system 120 may be a virtual server implemented using a number of computing systems connected in a grid or cloud computing topology.

A content management application 116 stored in the memory 108 can configure the processor 104 to render the electronic content 114 for display at the display device 118. In some embodiments, the content management application 116 can be a software module included in or accessible by a separate application executed by the processor 104 that is configured to modify, access, or otherwise use the electronic content 114. In other embodiments, the content management application 116 can be a stand-alone application executed by the processor 104.

A computer-readable medium may comprise, but is not limited to, electronic, optical, magnetic, or other storage device capable of providing a processor with computer-readable instructions. Other examples comprise, but are not limited to, a floppy disk, CD-ROM, DVD, magnetic disk, memory chip, ROM, RAM, an ASIC, a configured processor, optical storage, magnetic tape or other magnetic storage, or any other medium from which a computer processor can read instructions. The instructions may comprise processor-specific instructions generated by a compiler and/or an interpreter from code written in any suitable computer-programming language, including, for example, C, C++, C#, Visual Basic, Java, Python, Perl, JavaScript, and ActionScript.

The computing system 102 can include any suitable client devices for executing the content management application 116. Non-limiting examples of a computing device include a desktop computer, a tablet computer, a smart phone, or any other computing device suitable for rendering electronic content. In some embodiments, the display device 118 can be a touch screen device. A touch screen can include any electronic visual display that can detect the presence and location of a touch within the a display area defined by the touch screen. A touch can include a detection of an input object, such as a stylus or a finger, that is in contact with or in close proximity to the touch screen.

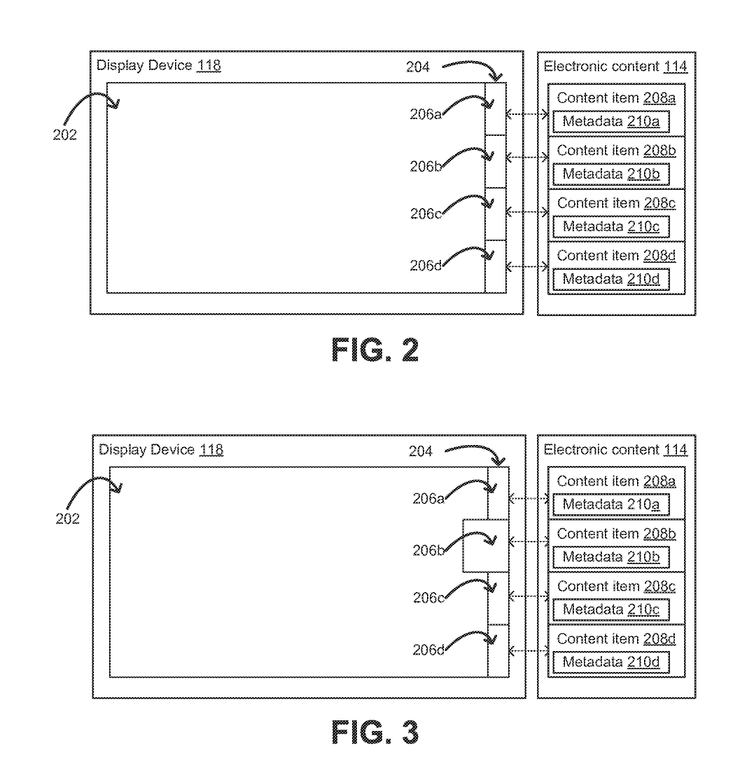

FIG. 2 is a modeling diagram illustrating an example navigation interface 204 for browsing electronic content items 208a-d. The content management application 116 can configure the processor 104 to render the navigation interface 204 for display on a display screen 202 of the display device 118. In some embodiments, the navigation interface 204 is rendered for display at an edge of the display screen 202, as depicted in FIG. 2. The navigation interface 204 may be rendered at any edge of the display screen 202. In other embodiments, the navigation interface 204 is rendered for display at other positions on the display screen 202.

The navigation interface 204 includes tabs 206a-d. Each of the tabs 206a-d is a visual indicator corresponding to at least one of the electronic content items 208a-d.

One or more of the electronic content items 208a-d may be associated with corresponding metadata 210a-d. Metadata 210b can include any information describing the electronic content item 208b. In one non-limiting example, an electronic content item 208b may be a video. Metadata 210b associated with the video may include the duration of the video, chapters in the video, a summary of the video content, an author of the video and the like.

Any suitable mechanism or process can be used to identify the electronic content items 208a-d corresponding to the tabs 206a-d. In one embodiment, the content management application 116 can populate the navigation interface 204 with tabs 206a-d based on automatically detecting the electronic content items 208a-d in one or more locations in the memory 108. For example, a content management application 116 may perform a search of one or more directories or other data structures of a memory 108 to identify one or more of video files, image files, multimedia presentations, and the like. The content management application 116 may generate a respective tab corresponding to each of the video files, image files, multimedia presentations, etc.

In another embodiment, the content management application 116 can populate with tabs 206a-d of the navigation interface 204 based on a playlist provided to or otherwise accessible by the content management application 116. The playlist can identify the electronic content items to be included in the navigation interface 204. The playlist can be stored in the memory 108. The playlist can also be provided by a content provider in communication with the content management application 116, such as a server system 120.

FIG. 3 is a modeling diagram illustrating selecting a tab 206b corresponding to an electronic content item 208b in the navigation interface 204. The content management application 116 increases the size of a tab 206b in response to an input to the navigation interface 204. In some embodiments, the content management application 116 increases the size of a tab 206b in a direction perpendicular to the orientation of the navigation interface 204. For example, as depicted in FIG. 3, for a navigation interface 204 oriented in a vertical direction, a tab 206b may expand in a horizontal direction (i.e., increase in width). For a navigation interface 204 oriented in a horizontal direction, a tab 206b may expand in a vertical direction (i.e., increase in height). In other embodiments, the content management application 116 increases the size of a tab 206b in a direction parallel to the orientation of the navigation interface 204. For example, for a navigation interface 204 oriented in a vertical direction, a tab 206b may expand in a vertical direction (i.e., increase in height). For a navigation interface 204 oriented in a horizontal direction, a tab 206b may expand in a horizontal direction (i.e., increase in width).

In some embodiments, the content management application 116 increases the size of each of the tabs 206a-d in response to a strumming motion. A strumming motion can include the display screen 202 receiving a constant input, such as a touch, along the length of the navigation interface 204 in either direction. For a strumming motion, an input occupying the majority of the area of a given tab, such as the tab 206b, may cause the given tab to expand in size. The input ceasing to occupy the majority of the area of a given tab, such as the tab 206b, may cause the given tab to decrease in size.

In some embodiments, the content management application 116 increases the size of each of the tabs 206a-d in response to a tapping input. The tapping input can include a single tap or a series of taps. A first tapping input occupying the majority of the area of a given tab, such as the tab 206b, may cause the given tab to expand in size. A second tapping input to the given tab may cause the given tab to decrease in size. A second tapping input occupying the majority of the area of a second given tab, such as the tab 206c, may cause the expanded tab 206b to decrease in size.

The content management application 116 can adaptively render the navigation interface 204 on the display device 118 based on display characteristics of the display device 118. Non-limiting examples of display characteristics include display screen size, a display screen shape, or a display screen resolution. The content management application 116 can modify the size of the navigation interface 204 based on at least one display characteristics of the display device 118. In some embodiments, the content management application 116 can modify the size of tabs within the navigation interface 204 based on display characteristics of the display device. In other embodiments, the content management application 116 can modify the number of tabs display on the display screen 202 based on display characteristics of the display device. For example, the content management application 116 can reduce the number of tabs displayed in the navigation interface 204. The content management application 116 can provide a scrolling feature that scrolls through the tabs.

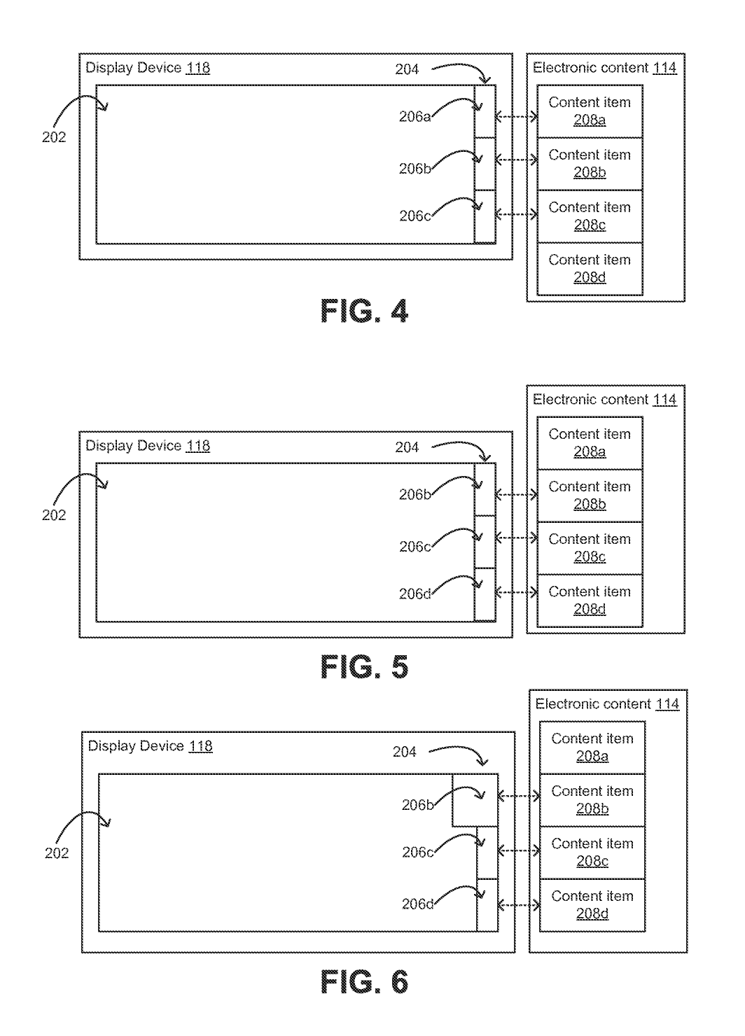

FIGS. 4-6 are modeling diagrams illustrating an example scrollable navigation interface 204 for browsing electronic content items 208a-d. FIG. 4 depicts the navigation interface 204 rendered for display on the display screen 202 with the three tabs 206a-c. A scrolling input can be received by the navigation interface 204. The scrolling input can cause the navigation interface 204 to scroll downward. FIG. 5 depicts the navigation interface 204 rendered for display on the display screen 202 with the three tabs 206b-d. FIG. 6 depicts the navigation interface 204 expanding a selected tab 206b of the tabs 206b-d.

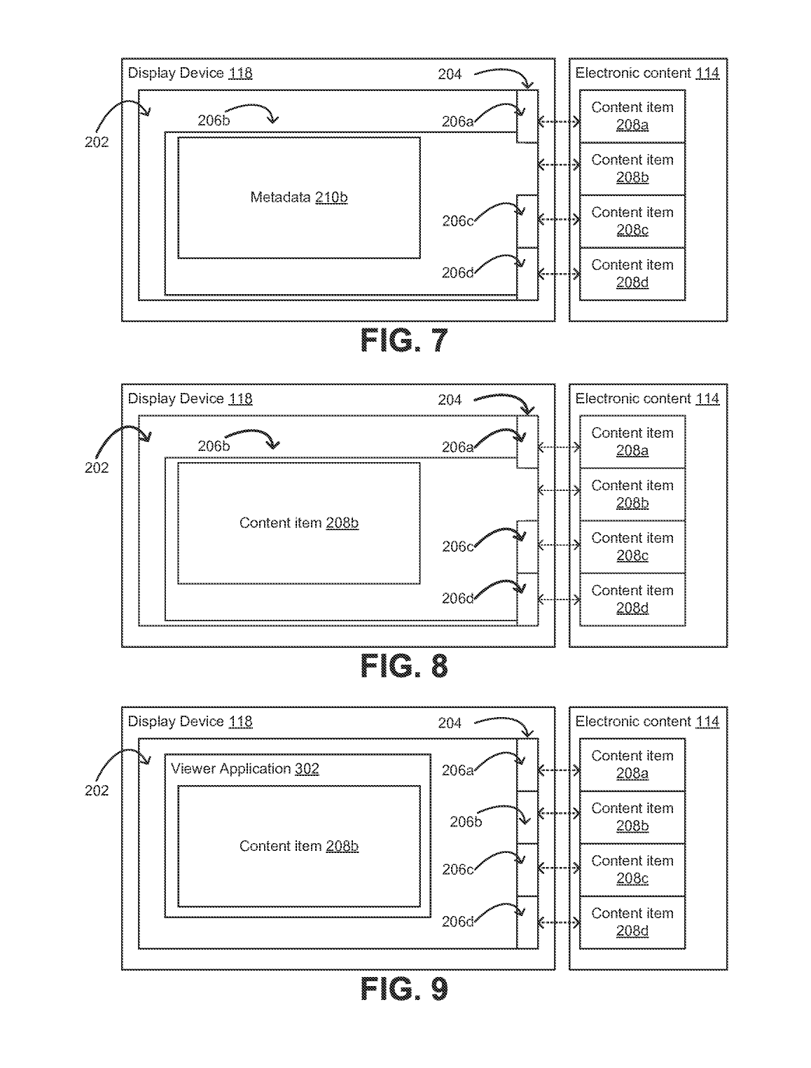

In some embodiments, the content management application 116 displays information about an electronic content item in response to the navigation interface 204 receiving one or more additional inputs indicative of selecting a tab corresponding to the electronic content item. FIG. 7 is a modeling diagram illustrating the navigation interface 204 displaying metadata 210b describing a selected electronic content item 208b in the scrollable navigation interface 204. The navigation interface 204 can display some or all of metadata 210b.

In other embodiments, the content management application 116 may cause an electronic content item to be rendered for display in response to the navigation interface 204 receiving inputs indicative of selecting a tab corresponding to the electronic content item. FIG. 8 is a modeling diagram illustrating the navigation interface 204 displaying a selected electronic content 208b item in a viewer application integrated within the navigation interface 204. The content management application 116 may include a viewer application module. The content management application 116 configures the processor 104 to execute the viewer application module in response to receiving one or more additional inputs indicative of selecting the tab 206b.

FIG. 9 is a modeling diagram illustrating the navigation interface 204 executing an external viewer application 302 for displaying a selected electronic content item 208b. The viewer application 302 may be a separate application from the content management application 116 that is stored in the memory 108. The viewer application 302 may be a standalone viewer application, such as (but not limited to) a video player or image viewer, or may be integrated into a separate application, such as (but not limited to) a web browser. The content management application 116 configures the processor 104 to execute the viewer application 302 in response to receiving one or more additional inputs indicative of selecting the tab 206b.

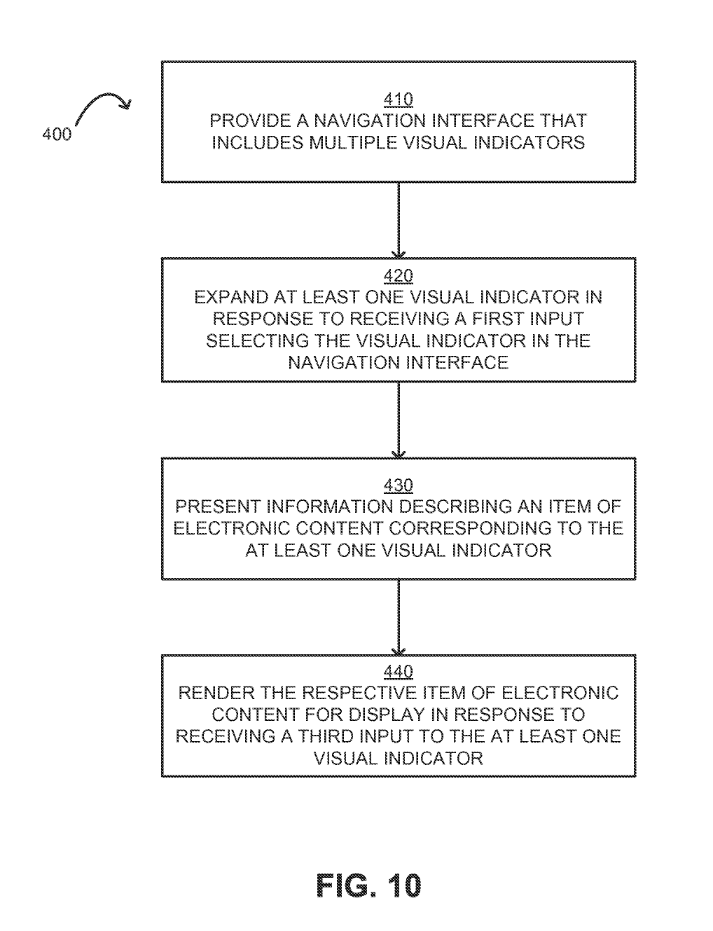

FIG. 10 is a flow chart illustrating an example method 400 for providing a navigation interface. For illustrative purposes, the method 400 is described with reference to the system implementation depicted in FIG. 1. Other implementations, however, are possible.

The method 400 involves providing a navigation interface 204 that includes multiple visual indicators, as shown in block 410. The processor 104 of the computing system 102 can execute the content management application 116 to providing the navigation interface 204. The visual indicators, such as the tabs 206a-d can correspond to electronic content items 208a-d.

In some embodiments, the navigation interface 204 is positioned at an edge of a display screen 202. The navigation interface 204 can be fully hidden or partially hidden when no input is received at a portion of the display screen 202 at which the navigation interface 204 is positioned. Hiding the navigation interface 204 can include the content management application preventing any of the tabs 206a-d from being rendered for display at the display screen 202. The navigation interface 204 can be rendered for display when input is received at the portion of the display screen 202 at which the navigation interface 204 is positioned. Non-limiting examples of such input include a mouse pointer being positioned over the navigation interface 204 or a touch screen receiving a touch at the edge of the screen at which the navigation interface 204 is positioned.

In additional or alternative embodiments, providing the navigation interface 204 can include identifying the electronic content items 208a-d to be represented by the visual indicators. The content management application 116 can identify the electronic content items 208a-d via any suitable mechanism, such as (but not limited to), receiving a playlist identifying the electronic content items 208a-d or receiving the electronic content items 208a-d in response to querying a data source using one or more search criteria corresponding to one or more attributes of the electronic content items 208a-d.

The method 400 further involves expanding at least one visual indicator, such as the tab 206b, in response to receiving a first input selecting the at least one visual indicator in the navigation interface, as shown in block 420. The processor 104 can execute the content management application 116 to expand the tab 206b. A non-limiting example of a first input is a strumming input.

The method 400 further involves presenting information describing a respective item of electronic content corresponding to the at least one visual indicator, such as the content item 208b corresponding to the tab 206b, in response to receiving a second input to the at least one visual indicator, as shown in block 430. Non-limiting examples of a second input include a single tapping motion, a swiping motion, or a flicking motion. The processor 104 can execute the content management application 116 to present information describing a respective item of electronic content. For example, the content management application 116 can render the metadata 210b associated with the content item 208b. The metadata 210b describing the electronic content item 206b may include one or more of a duration of the electronic content item 206b, a textual summary of the electronic content item 206b, a thumbnail image (such as a screenshot from a video) representative of the electronic content item 206b, a title of the respective item of the electronic content item 206b, an author of the electronic content item 206b, and the like.

The method 400 further involves rendering the respective item of electronic content for display in response to receiving a third input to the at least one visual indicator, as shown in block 440. The processor 104 can execute the content management application 116 to render the item of electronic content. For example, the content management application 116 can render the content item 208b.

In some embodiments, each of the first, second, and third inputs may be a different type of input. For example, a first input may be a strumming motion, the second input may be a single tap, and the third input may be a double tap. The navigation interface 204 may thus provide progressively more access to an item of electronic content.

In additional or alternative embodiments, none of the electronic content items 208a-d may be rendered for display prior to the navigation interface 204 receiving the first input. The navigation interface 204 may provide a persistent interface for navigating to and executing various electronic content items or for displaying information about the various electronic content items without rendering the content items for display.

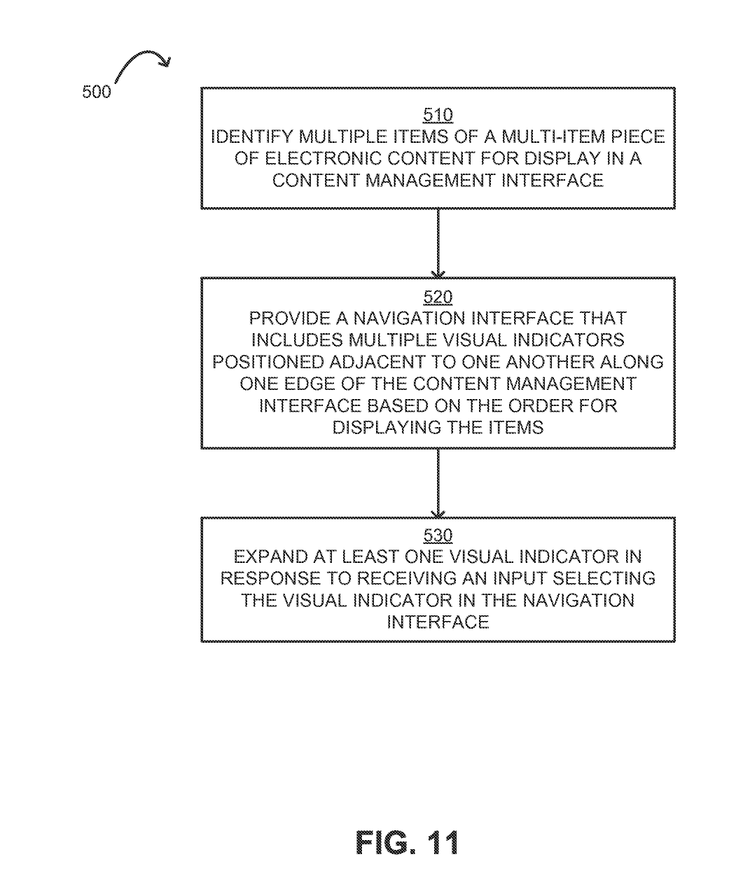

FIG. 11 is a flow chart illustrating an alternative example method 500 for providing a navigation interface. For illustrative purposes, the method 500 is described with reference to the system implementation depicted in FIG. 1. Other implementations, however, are possible.

The method 500 involves identifying multiple electronic content items 208a-d of a multi-item piece of electronic content 114 for display in a content management interface of the content management application 116, as shown in block 510. The processor 104 of the computing system 102 can execute the content management application 116 to identify the electronic content items 208a-d. The visual indicators, such as the tabs 206a-d can correspond to electronic content items 208a-d. The tabs 206a-d can be rendered for display in an order associated with the multi-item piece of electronic content.

In an example embodiment, a non-limiting example of a multi-item piece of electronic content 114 is a multimedia application or file including multiple items of electronic content. One non-limiting example of a multimedia application or file is an issue of a digital magazine wherein each page or each article of the digital magazine is an electronic content item. An order associated with the digital magazine can be an order of pages and/or order of articles within the digital magazine. Each of the tabs 206a-d can correspond to an article or page of the digital magazine. Another non-limiting example of a multimedia application or file is a digital video presentation wherein each scene or chapter of the digital video presentation is an electronic content item. An order associated with the digital video presentation can be an order of scenes and/or order of chapters within the digital video presentation. Each of the tabs 206a-d can correspond to a scene or chapter of the digital video presentation. Another non-limiting example of a multimedia application or file is a playlist identifying multiple audio or video files, wherein each audio or video files is an electronic content item. An order associated with the playlist can be an order of audio or video files as specified in the playlist. Each of the tabs 206a-d can correspond to a separate audio or video file.

The method 500 further involves providing the navigation interface 204 that includes the visual indicators, such as tabs 206a-d, positioned adjacent to one another along one edge of the content management interface based on the order for displaying the items, as shown in block 520. For example, as displayed in FIGS. 2-9, each of the tabs 206a-d can be positioned along an edge of the display screen 202. Each of the tabs 206a-d can correspond to an item of electronic content. The order of the tabs 206a-d as rendered for display on the display screen 202 is based on the order associated with the multi-item piece of electronic content 114.

The method 500 further involves expanding at least one visual indicator, such as the tab 206b, in response to receiving an input selecting the at least one visual indicator in the navigation interface, as shown in block 530. The processor 104 can execute the content management application 116 to expand the tab 206b.

A non-limiting example of an input is a strumming input. A strumming input can include a motion along a display device 118 that is a touch screen. The motion can correspond to the edge of the display screen 118. Visual indicators along a path of the motion, such as the tabs 206a-d, can expand and contract in a sequence corresponding to the motion along the touch screen. For example, as depicted in FIGS. 2-9, a strumming motion from the top of the navigation interface 204 to the bottom of the navigation interface 204 can first cause tab 206a to expand and contract, then cause tab 206b to expand and contract, then cause tab 206c to expand and contract, and then cause tab 206d to expand and contract. A strumming motion from the bottom of the navigation interface 204 to the top of the navigation interface 204 can first cause tab 206d to expand and contract, then cause tab 206c to expand and contract, then cause tab 206b to expand and contract, and then cause tab 206a to expand and contract.

In additional or alternative embodiments, one or more visual indicators can be repositioned to accommodate an expanded size of at least one visual indicator. For example, if a tab 206b is expanded, the tabs 206a, 206c, 206d can be re-positioned on the navigation interface 204.

In additional or alternative embodiments, one or more visual indicators adjacent to an expanded visual indicator can also be expanded. The adjacent visual indicators can be expanded to a different size less that is less than the expanded size of a selected visual indicator. For example, if a tab 206b is expanded, the tabs 206a, 206c, can be expanded to be larger than tab 206d and smaller than tab 206a.

### General Considerations

Numerous specific details are set forth herein to provide a thorough understanding of the claimed subject matter. However, those skilled in the art will understand that the claimed subject matter may be practiced without these specific details. In other instances, methods, apparatuses, or systems that would be known by one of ordinary skill have not been described in detail so as not to obscure claimed subject matter.

Unless specifically stated otherwise, it is appreciated that throughout this specification discussions utilizing terms such as “processing,” “computing,” “calculating,” “determining,” and “identifying” or the like refer to actions or processes of a computing device, such as one or more computers or a similar electronic computing device or devices, that manipulate or transform data represented as physical electronic or magnetic quantities within memories, registers, or other information storage devices, transmission devices, or display devices of the computing platform.

The system or systems discussed herein are not limited to any particular hardware architecture or configuration. A computing device can include any suitable arrangement of components that provide a result conditioned on one or more inputs. Suitable computing devices include multipurpose microprocessor-based computer systems accessing stored software that programs or configures the computing system from a general purpose computing apparatus to a specialized computing apparatus implementing one or more embodiments of the present subject matter. Any suitable programming, scripting, or other type of language or combinations of languages may be used to implement the teachings contained herein in software to be used in programming or configuring a computing device.

Embodiments of the methods disclosed herein may be performed in the operation of such computing devices. The order of the blocks presented in the examples above can be varied—for example, blocks can be re-ordered, combined, and/or broken into sub-blocks. Certain blocks or processes can be performed in parallel.

The use of “adapted to” or “configured to” herein is meant as open and inclusive language that does not foreclose devices adapted to or configured to perform additional tasks or steps. Additionally, the use of “based on” is meant to be open and inclusive, in that a process, step, calculation, or other action “based on” one or more recited conditions or values may, in practice, be based on additional conditions or values beyond those recited. Headings, lists, and numbering included herein are for ease of explanation only and are not meant to be limiting.

While the present subject matter has been described in detail with respect to specific embodiments thereof, it will be appreciated that those skilled in the art, upon attaining an understanding of the foregoing may readily produce alterations to, variations of, and equivalents to such embodiments. Accordingly, it should be understood that the present disclosure has been presented for purposes of example rather than limitation, and does not preclude inclusion of such modifications, variations, and/or additions to the present subject matter as would be readily apparent to one of ordinary skill in the art.

1. A method comprising:
providing, by a content management application executed by a processor, a navigation interface, wherein the navigation interface comprises a plurality of visual indicators, each visual indicator corresponding to an item of electronic content;
in response to receiving a first input selecting at least one of the plurality of visual indicators in the navigation interface, expanding, by the content management application, the at least one visual indicator;
in response to receiving a second input to the at least one visual indicator, presenting information describing a respective item of electronic content corresponding to the at least one visual indicator; and
in response to receiving a third input to the at least one visual indicator, rendering, by the content management application, the respective item of electronic content for display.

2. The method of claim 1, wherein the navigation interface is positioned at an edge of a touch screen in communication with the processor.

3. The method of claim 1, wherein providing the navigation interface comprises identifying each item of electronic content based on a playlist received by the content management application.

4. The method of claim 1, wherein providing the navigation interface comprises determining that each item of electronic content includes one or more attributes corresponding to at least one search criterion received by the content management application.

5. The method of claim 1, wherein each of the first input, the second input, and the third input comprises a different type of input to a touch screen in communication with the processor.

6. The method of claim 5,
wherein the first input comprises a strumming input;
wherein the second input comprises at least one of a single tapping motion, a swiping motion, or a flicking motion;
wherein the third input comprises at least one of a plurality of tapping motions.

7. The method of claim 1, wherein the information describing the respective item of electronic content comprises at least one of a duration of the respective item of electronic content, text summarizing the respective item of electronic content, a thumbnail image representative of the respective item of electronic content, a title of the respective item of electronic content, or an author of the respective item of electronic content.

8. The method of claim 1, wherein none of the items of electronic content are rendered for display by the processor prior to the navigation interface receiving the first input.

9. The method of claim 1, further comprising, prior to providing the navigation interface, identifying a plurality of electronic content items of a multi-item piece of electronic content for display in a content management interface of the content management application, wherein the multi-item piece of electronic content is associated with an order for displaying the electronic content items, wherein the plurality of visual indicators are positioned adjacent to one another along one edge of the content management interface based on the order for displaying the electronic content items.

10. A non-transitory computer-readable medium embodying program code executable by a processing device, the non-transitory computer-readable medium comprising:
program code for identifying a plurality of electronic content items of a multi-item piece of electronic content for display in a content management interface, wherein the multi-item piece of electronic content is associated with an order for displaying the electronic content items;
program code for providing a navigation interface on the content management interface, wherein the navigation interface comprises a plurality of visual indicators positioned adjacent to one another along an edge of the content management interface based on the order for displaying the electronic content items, each visual indicator corresponding to an item of electronic content; and
program code for, in response to receiving an input selecting at least one of the plurality of visual indicators in the navigation interface, expanding the at least one visual indicator to an expanded size.

11. The non-transitory computer-readable medium of claim 10, wherein the input comprises a strumming motion along a touch screen corresponding to the edge of the content management interface, wherein visual indicators along a path of the motion expand and contract in a sequence corresponding to the motion along the touch screen.

12. The non-transitory computer-readable medium of claim 10, further comprising program code for repositioning at least one additional visual indicator to accommodate the expanded size of the at least one visual indicator.

13. The non-transitory computer-readable medium of claim 10, further comprising program code for expanding adjacent visual indicators that are adjacent to the at least one visual indicator in the navigation interface, wherein the adjacent visual indicators are expanded to a second expanded size less than the expanded size of the at least one visual indicator.

14. The non-transitory computer-readable medium of claim 10, further comprising
program code for expanding the at least one visual indicator in response to receiving a first input selecting at least one of the plurality of visual indicators in the navigation interface;
program code for presenting information describing a respective item of electronic content corresponding to the at least one visual indicator in response to receiving a second input to the at least one visual indicator; and
program code for rendering the respective item of electronic content for display in response to receiving a third input to the at least one visual indicator.

15. The non-transitory computer-readable medium of claim 14, further comprising:
program code for determining a size of the navigation interface based on at least one display characteristic of a display device at which the navigation interface is rendered.

16. The non-transitory computer-readable medium of claim 15, wherein the at least one display characteristic comprises at least one of a display screen size, a display screen shape, or a display screen resolution.

17. The non-transitory computer-readable medium of claim 16, further comprising:
program code for rendering a first subset of the plurality of visual indicators based on the size of the navigation interface; and
program code for scrolling the first subset to a second subset of the plurality of visual indicators based on receiving a scrolling input.

18. A system comprising:
a touch screen configured to detect a touch input within a display area defined by the touch screen;
a processor in communication with the touch screen, the processor configured to execute instructions comprised in a non-transitory computer-readable medium, the instructions comprising a content management application;
wherein the content management application comprises one or more modules configured to perform operations comprising:
rendering a navigation interface for display at the touch screen, wherein the navigation interface comprises a plurality of visual indicators, each visual indicator corresponding to an item of electronic content;
expanding at least one visual indicator in response to receiving a first input selecting the at least one visual indicator in the navigation interface;
presenting information describing a respective item of electronic content corresponding to the at least one visual indicator in response to receiving a second input to the at least one visual indicator; and
rendering the respective item of electronic content for display in response to receiving a third input to the at least one visual indicator.

19. The system of claim 18, wherein the information describing the respective item of electronic content comprises at least one of a duration of the respective item of electronic content, text summarizing the respective item of electronic content, a thumbnail image representative of the respective item of electronic content, a title of the respective item of electronic content, or an author of the respective item of electronic content.

20. The system of claim 18, wherein rendering the respective item of electronic content for display comprises executing a viewer application configured to render the respective item of electronic content, wherein the viewer application is separate from the content management application.
